(19) United States
(12) Patent Application Publication
(10) Pub. No.: US 2021/0406902 A1
(43) Pub. Date: Dec. 30, 2021

(54) STANDARDIZED IDENTIFIERS FOR MULTIPLE TRANSACTION AUTHORIZATIONS

(71) Applicant: Synchrony Bank, Stamford, CT (US)

(72) Inventors: Deborah Bernert, Stamford, CT (US); Taylor Young, Stamford, CT (US); Jonathan M. Schmidt, Stamford, CT (US); Craig Urbansky, Stamford, CT (US); Viveka Vardhan Ravi, Stamford, CT (US)

(73) Assignee: Synchrony Bank, Stamford, CT (US)

(21) Appl. No.: 17/357,849

(22) Filed: Jun. 24, 2021

Related U.S. Application Data
(60) Provisional application No. 63/043,630, filed on Jun. 24, 2020.

(51) Int. Cl. G06Q 20/40; H04L 29/06; G06Q 20/02; G06Q 20/08; G06Q 20/38

(52) U.S. Cl. CPC G06Q 20/4097; H04L 63/083; G06Q 20/02; G06Q 20/12; G06Q 20/385; G06Q 20/4014; G06Q 20/4037; G06Q 20/085

(57) ABSTRACT

Examples described herein include systems, methods, instructions, and other implementations for data security. One example includes receiving a checkout communication associated with a secure transaction, where the checkout communication includes a first child merchant identifier associated with a first child merchant system, a second child merchant identifier associated with a second child merchant system, and a parent merchant identifier associated with a parent merchant system. The parent merchant identifier is associated with multiple different child merchant identifiers. The parent merchant system is then authenticated using the parent merchant identifier. The authentication of the parent merchant system is then used to facilitate payments with the multiple different child merchant systems.

### CROSS REFERENCE TO RELATED APPLICATIONS

This application claims priority to U.S. Provisional Application 63/043,630, filed on Jun. 24, 2020, the entire content of which is incorporated herein by reference.

### FIELD

The present disclosure relates generally to data security and transactions. In one example, the systems and methods described herein may be used to implement data security and facilitate transaction authorization and settlement in a variety of transactional contexts, and particularly modular integration of data security in transaction websites.

### BACKGROUND

Clients often seek to obtain and use credit from a lending institution for a variety of purposes. In some circumstances, a client may interact with a merchant in an environment where the client does not have access to the client's account number, or where the client prefers additional security and protection for the client's data. Additionally, in some circumstances, a client may interact with a single entity to make a single payment to multiple different merchants. Managing a transaction in such environments can create barriers to completing transactions between clients, merchants, and lenders. Additionally, other considerations can be involved in such transactions, such as lender and merchant concerns related to fraud, and regulatory controls on data sharing when the data used in such transactions can be subject to a variety of privacy and regulatory considerations. Such considerations can further create barriers in the context of network communications and data management in a communication system for the data used to facilitate credit options and associated purchase transactions.

### SUMMARY

Disclosed examples may provide systems to provide data security while allowing efficient payment and settlement to a set of merchants grouped within a system under the umbrella of a parent organization. Various implementations can allow merchants to organize together as child merchants under a parent merchant structure. This can allow harmonized interface configurations in website interfaces for child merchants operating under the parent structure. This can also allow efficient transactions involving multiple child merchants, where a transaction authentication occurs at a parent merchant level. In the same transaction, authorization, payments, and associated settlements to child merchants can occur individually while these individual operations rely on the parent merchant authentication. This can allow groups of merchants that naturally perform services together to provide simple transactions to a client, while limiting the back-end operations for the child merchants to distribute the single payment from the client among the child merchants. This can also allow system analytics for merchants that provide services together. Examples of such merchants can include independent doctor groups operating for a hospital or insurance network, construction groups with sub-contractors, vehicle repair shops with independent contractors, Internet websites that sell products for independent producers or multiple different merchants, and other such systems.

Examples allow such organizations to provide efficient transactions in a secure network. One implementation can involve an account security system receiving a checkout communication associated with a secure transaction, where the checkout communication is structured to include a first child merchant identifier associated with a first child merchant system, a second child merchant identifier associated with a second child merchant system, and a parent merchant identifier associated with a parent merchant system. The parent merchant identifier can be associated with the first child merchant identifier and the second child merchant identifier. In such an implementation, the first child merchant system and the second child merchant system are associated with different merchants. The parent merchant system can then be authenticated using the parent merchant identifier. The secure transaction can then proceed with facilitating processing of a first payment of the secure transaction, where processing is facilitated using the first child merchant identifier, and where processing is based on authentication of the parent merchant system. A second payment can also be performed concurrently or after the first payment. The secure transaction can thus include facilitating processing of a second payment of the secure transaction, where processing is facilitated using the second child merchant identifier, and where processing is based on authentication of the parent merchant system.

Some examples include structures to implement data security for client data used as part of a network transaction, and to manage merchant access to tokenized client data that protects client data security while facilitating transactions. In some merchant systems, for example, an independent structure for transaction authorization can be implemented, where a merchant may want to also offer secure validation of client accounts. Examples described herein include systems and methods that allow account number lookup and account number validation to be enabled within a merchant system while protecting client data from the merchant system. These data lookup operations can be done with a security system that validates the merchant system, and then interacts with a client system to perform lookup or validation for client data while maintaining client data security.

In one example, a data security system can be invoked via an interface element included in a merchant user interface. Selection of the interface element can be used as part of a secure transaction to allow a client to perform an account lookup operation or an account validation operation. In some such examples, selection of the associated interface element by a client device interacting with a merchant website causes a checkout communication to be initiated by a merchant system. When the checkout communication is received at an account security system that will facilitate the account lookup or verification as part of the secure transaction, the account security system initially uses the checkout communication to authenticate the merchant system (e.g. confirming that the checkout communication is from a validated checkout system).

The data security system can then generate a client token for the merchant system that can be sent to the client device to confirm that the merchant system has been validated. The client device can then open a modal (e.g. an interface overlay on top of the merchant website interface) that is used for a communication channel with the account security system. This modal allows the merchant website to maintain a consistent look, feel, and interface flow while isolating the merchant system from sensitive client data. The communication channel between the client device and the account security system can be used to transmit identifying client information to the account security system, so that the account security system can provide information for the secure transaction. Account security can include account lookup information, such as providing an account number to a client. Account security can also include account verification, including verifying an account number and providing account details such as an available balance. This account data can then be tokenized to provide security and to isolate the merchant system from the actual data. When the client device is done communicating with the account security system, the tokenized data is then available to be provided to a merchant system if requested by the merchant system for use in completing a secure transaction. The tokens (e.g., tokenized client account numbers) can be automatically generated in real-time or near real-time, and such automatic operations can be performed thousands of times per second or more in accordance with examples described herein. Similarly, data for thousands or tens of thousands of transactions can be stored in a memory or associated database of a device to be available for real-time access during secure transactions as described herein.

Such examples can be implemented with various methods in an account security system. In some examples, the account security system can perform additional operations including receiving a checkout communication associated with a secure transaction. As described above, an account security system can function where the checkout includes data describing a validated checkout system, and where, when the checkout communication is received from a merchant system, the checkout communication does not include client information. The account security system can then process the checkout communication to authenticate that the checkout communication is from the validated checkout system, and generate a client token in response to an authentication that the checkout communication is from the validated checkout system. The client token can then be transmitted, so that when the client token is received at the client device, the client token is used to verify the merchant system. The account security system then receives an account communication including the client token and client information (e.g. where the client information is not received from the merchant system), and generates a tokenized client account number in response to the account communication. The tokenized client account number is then transmitted for use in facilitating the secure transaction, where the tokenized client account number allows the merchant system to process the secure transaction without access to the client information. The associated operations can occur in real-time (e.g., occurring immediately or nearly immediately within the context of communications that occur over a fixed amount of time, such as within 1 second) during a transaction to add security to transactions and associated real-time communications. Examples described herein improve the operation of devices and networks with improved security and privacy that can be added to existing devices and networks in real-time secure communication environments.

Additional examples or variations can include further security operations to confirm the security of a client device, and to enable interactions with other systems as part of a secure transaction. The examples described above improve the operation of transaction communications systems and devices in such communication systems by improving device security and security of sensitive data within such devices and systems. Additionally, interfaces described herein improve both the operation of devices displaying such interfaces and communication systems used by such devices by improving the operation flow and reducing the number of user actions to perform operations as part of a secure transaction, as well as by enabling new functionality in system devices.

This summary is not intended to identify key or essential features of the claimed subject matter, nor is it intended to be used in isolation to determine the scope of the claimed subject matter. The subject matter should be understood by reference to appropriate portions of the entire specification of this patent application, any or all drawings, and each claim.

The foregoing, together with other features and examples, will be described in more detail below in the following specification, claims, and accompanying drawings.

### BRIEF DESCRIPTION OF THE DRAWINGS

The present disclosure is described in conjunction with the appended figures:

FIG. 1 depicts aspects of a system that can be used for data security and transaction management in accordance with examples described herein.

FIG. 2 depicts aspects of an account security system for implementing data security and transaction management in accordance with some examples.

FIG. 3 depicts aspects of a system and system operations for data security and transaction management in accordance with some examples.

FIG. 4 depicts aspects of a system and user interfaces for data security and transaction management in accordance with some examples.

FIG. 5 depicts aspects of a system and user interfaces for data security and transaction management in accordance with some examples.

FIG. 6 depicts aspects of standardized identifiers for multiple transaction authorizations that can be used with systems and methods for data security and transaction management in accordance with examples described herein.

FIG. 7 depicts aspects of standardized identifiers for multiple transaction authorizations that can be used with systems and methods for data security and transaction management in accordance with examples described herein.

FIG. 8 depicts aspects of a system and system operations for data security and transaction management in accordance with some examples.

FIG. 9 is a flow diagram illustrating a method in accordance with some examples.

FIG. 10 shows a computing system architecture including various components in electrical communication with each other using a connection in accordance with various examples.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides examples of embodiment(s) only and is not intended to limit the scope, applicability or configuration of the disclosure. Rather, the ensuing description of the examples of embodiment(s) will provide those skilled in the art with an enabling description for the described implementations. In the following description, for the purposes of explanation, specific details are set forth in order to provide a thorough understanding of certain inventive embodiments. It is understood that various changes can be made in the function and arrangement of elements without departing from the spirit and scope as set forth in the appended claims. Additionally, it will be apparent that various embodiments may be practiced without these specific details. The figures and description are not intended to be restrictive.

In some transaction environments, communications and security for multiple independent merchants can be integrated to provide a customer a simplified transaction. Rather than having multiple transactions for each independent merchant (e.g. child merchants), a single transaction can be implemented using a parent merchant structure to aggregate the transactions with the child merchants. This can, for example, occur where a customer is a patient of a medical practice with multiple independent service providers, in an online storefront where different merchants can sell via the storefront, or in other such circumstances. Examples described herein include systems, methods, instructions, and other implementations for data security and transaction management in such circumstance.

In one example, an account security system can be configured with information for a parent merchant that is structured as an umbrella or aggregating system for multiple client merchants. The account security system performs initial verification of the parent merchant structure and the client merchants, and identifiers are assigned to the parent merchant each child merchant associated with the parent merchant. When a customer initiates a transaction with two or more child merchants within a context associated with the parent merchant, the parent merchant system sends a checkout communication to the account security system. In different examples, the parent merchant system can be independent from child merchant systems, or can be integrated with the child merchant systems. The checkout communication includes a merchant identifier (MID) for the parent, as well as a child MID for each child merchant involved in the transaction. The checkout communication can also include additional transaction information for the secure transaction, such as one or more transaction type values, product codes for the different parts of the transaction (e.g. one or more product codes for each child MID), product codes (e.g., codes associated with an item, product, service, etc.), partner codes (e.g., codes for an affiliated organization, related organization, etc.), and other such information.

When the checkout communication is received at the account security system, the security authentication is performed at the parent level (e.g. using the parent MID and security protocols structured for the parent). This authentication involves generating a client token, which can then be used for security as the account security system, merchant systems, and client devices communicate to perform the secure transaction. As described below, while authorization and settlement then occurs at the child MID level, the initial authentication at the parent level is then used for later authorization and settlement that occurs at the child MID level. Following the parent level authentication and then during and after the child level authorization and settlement, an account security system can provide various operations in a secure environment, including facilitating applications for credit, account data lookup operations, account payment authorization operations, and other such transaction operations.

Examples described herein improve the operation of devices and networks for transactions by reducing the number of communications and the processing resources to independently authenticate multiple child merchants. Some examples can additional improve data security in a transaction with multiple merchants, and allow devices and networks to offer additional functionality in a secure environment.

Such implementations can provide improve transaction networks in a variety of organizational structures. For example, a hospital group can, in some circumstances, operate as a parent merchant, with a variety of independent doctor groups and support organizations each structured as independent child merchants configured to receive separate payment for products and services as part of a single transaction. A single transaction can, for example, include payments to a primary contact doctor, multiple supporting doctors, a nursing care provider, a surgery room provider, a pharmaceutical provider, and other such providers, each operating as a separate child merchant under the umbrella of a parent merchant that structures payments for a medical procedure as a single transaction. Rather than having a client make individual payments, or having the client make a single payment that settles with the parent such that additional transactions between the parent and child organizations are needed, examples described herein allow the client to perform a single transaction with parent merchant authentication, and individual child merchant authorization and/or settlement.

Similarly, an automobile repair shop can be organized as a parent merchant with child merchants for different portions of a repair. Glass replacement, body work, and engine repair can each be performed by different repair specialists each structured as separate child merchants. As described herein, a client can perform a single transaction with authentication performed with the parent merchant, and authorization and settlement occurring with each individual child merchant. This limits the number of transactions for a client, while allowing settlement to each child merchant in the context of the single transaction, improving the efficiency of the payment network and devices in the payment network.

Such improvements, can, in some examples, operate in a modular website environment. This modular function can be implemented with a checkout button associated with an account security system to be added to a website. This button allows an interface for account lookup and verification to facilitate custom payment solutions selected by a merchant. The button is provided to client devices as part of a web page user interface from a merchant system. When a client interacting with a merchant website clicks the described modular button, various operations for account security are initiated. The merchant system responds to this selection by communicating with an account security system to authenticate the merchant system. The account security system can then return a client token and postback identifier if the merchant is authenticated. This response information can be used to initiate a modal on the client's device as part of the merchant website user interface. The modal can appear as integrated with the merchant website, but rather than using the existing channel between the client device and the merchant system, the modal uses a separate communication channel between the client device and the account security system. This channel allows the client to provide sensitive client information as part of client verification or account access (e.g. for account lookup or account verification operations). The account security system can then generate tokenized client data for use with the merchant. The tokenized client data keeps the regular client data secure and separate from the merchant system, while allowing the merchant system to perform operations for a secure transaction, so that the merchant can receive payment while only having access to secure (e.g. tokenized) client data that does not put the clients sensitive information at risk.

In addition to the operations described above, the initial modal and channel between the client device and the account security system can be initiated, in some examples, only after the client device has been determined to be secure (e.g. using a security analysis of the device). Additionally, other examples can add additional security operations, or can perform different operations for any number of accounts associated with clients. As the account security system is modular and independent of other operations for a secure transaction, after the account validation is performed and the tokenized client data is generated, the merchant device can interact with separate independent systems to finalize and settle the secure transaction. In various examples, the account security system may communicate with such independent systems to facilitate the use of the tokenized data. Details of selected examples are below, though it will be apparent that additional implementations are possible other than the specific examples provided.

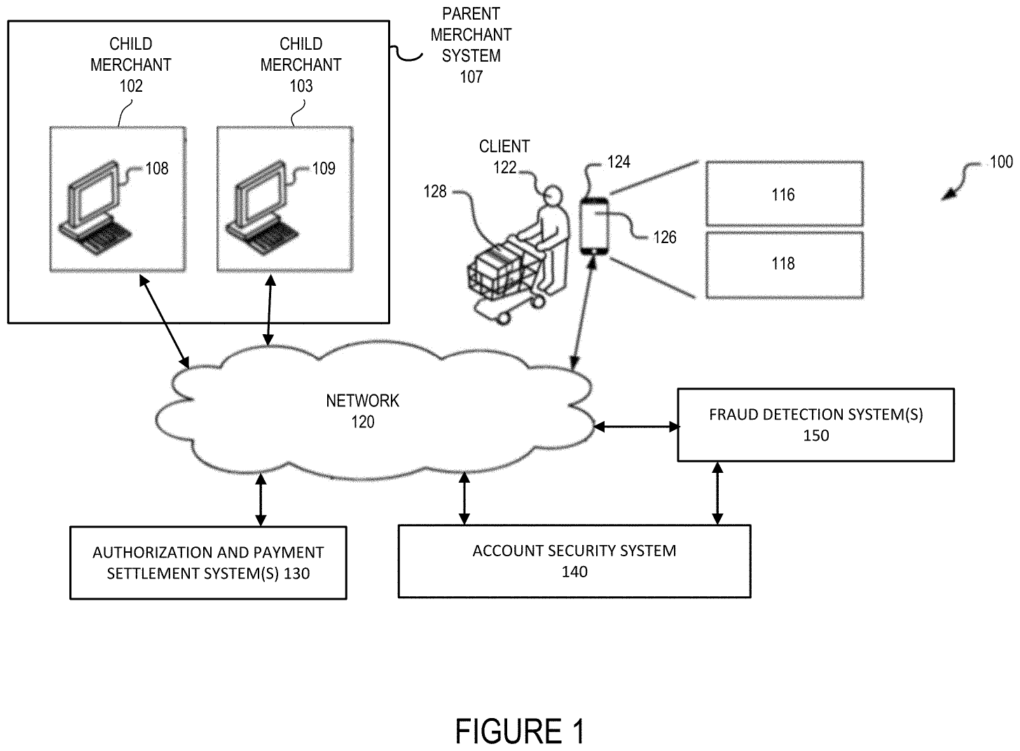

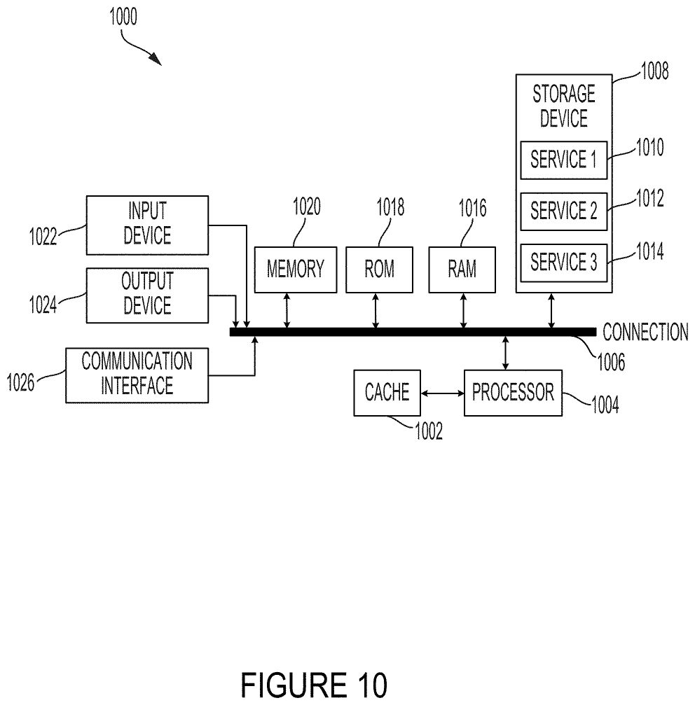

FIG. 1 is a block diagram of a payment communication network 100 in which network data management and security for transactions is implemented in accordance with some examples. The example payment communication network 100 includes a plurality of child merchants shown as child merchant 102 and child merchant 103 each implementing an associated child merchant system, shown as child merchant system 108 and child merchant system 109. Each child merchant system can be one or more networked computing devices that can be networked. For example, child merchant system 108 can include any number of devices (e.g. a checkout register, point of sale (POS) devices, or any other such device) as well as server systems and computers that implement a website that can be used to perform secure transactions over a network 120. Parent merchant system 107 can be an independent set of networked computing devices that implement a website with a transaction system that operates to sell product on behalf of the first and second child merchants, along with any number of other child merchants. In some examples, the parent merchant systems are integrated with the child merchant systems, so that each child system can have a separate set of devices or separate websites that are interconnected to allow checkout and authentication using a parent merchant identifier. In other examples, the parent merchant systems are independent, and are implemented with separate server computing devices. In some examples, a child can be affiliated or associated with multiple parent systems. In such an example, a child system will have a separate child merchant identifier for each parent merchant that the child merchant is associated with. Any device of a parent or child merchant system can be implemented as a computing device with architecture 1000 described below and illustrated in FIG. 10.

Referring to FIG. 1, the example parent merchant system 107 is configured to manage operations associated with a purchase transaction for a client 122 and a plurality of products 128. In some examples, a client can use a client device 124 (e.g., a cellular telephone, laptop computer, a desktop computer, etc.) associated with a client account to interact with parent merchant system 107 as part of a secure transaction for products from multiple child merchants 102 and 103 associated with a single parent merchant system 107, such that a single transaction can be used for a purchase from multiple child merchants. Some examples of a client device 124 can include a display device 126 (e.g., a conventional touch screen) and wireless or wired network connections to network 120. The client device 124 includes software 116 that can additionally cause display of user interfaces 118 on display device 126 in accordance with various examples. This can include, as described herein, web browser software as part of software 116 that can display a user interface using data received from a website of parent merchant system 107.

A client 122 may select or receive an invoice for a plurality of products 128 for purchase via interface(s) of a merchant's website. This can be a child merchant website or a parent merchant website, depending on the organization of the transaction system. When the client device 124 interacts with a merchant system via a website interface, the merchant system can use a payment channel based on the particular client device 124 and options selected by client 122.

The merchant system generates and communicates an authorization request message with authorization and payment settlement system(s) 130 as part of a secure transaction. The authorization request message can be routed to an authorization system, with the authorization system 130 processing the authorization request message to generate an authorization response.

An authorization entity can operate one or more authorization computing devices as part of an authorization system 130 configured as part of a payment communication network 100. The authorization system 130 can include various sub-systems or component functions implemented on processors of the authorization system to enable authorization of payment transactions between client 122 and merchant 102. The authorization system 130 can include validation and fraud systems as well as a promotion system. These systems can be systems that operate in addition to similar systems of account security system 140 or independent fraud detection system 150. Validation and fraud systems of system 130 can include computing systems for validating card numbers from client device 124 to confirm that credit or payment funds are available to match the purchase amount associated with a transaction being authorized. Additional fraud analysis operations can analyze and process information associated with any aspect of a transaction to approve or deny an authorization request.

In addition to the systems described above, an authorization system can in various implementations, include additional systems for security, fraud detection, and other functionalities. Some implementations can include a token service that can act in a number of ways to facilitate secure communications between client 122 and various other services and devices, including retail merchant system 108 and other systems. Tokenization is a process of substituting sensitive data elements with non-sensitive equivalents (e.g. tokens). The token is a reference identifier that can be mapped to the sensitive data via token service. Such a token service can use large random number in combination with other systems, such as timing systems, to limit and secure the use of sensitive data being communicated over networks such as networks 120.

As described above, in some examples, authorization system 130 can be integrated with other systems, such as a credit issuing system and communication channels with a client 122 outside the authorization channels used to communicate authorization request messages and responses between merchant devices and devices of an authorization system (e.g. authorization system 130). In such a system various additional functionality can be integrated for security and payment systems improvements, such as the use of token services as described above. Additionally, while FIG. 1 illustrates communications between various systems and devices, including merchant system 108, client device 124, authorization system 130, account security system 140, fraud detection system 150, and network 120, in additional examples, other aspects of payment communication network 100 can further be altered or include additional or intervening elements, such as multiple clients, clients with shared accounts and devices, additional merchant or retailer systems, subsystems that can operate independently, additional communication channels, or other such structures.

Fraud detection system(s) 150 can include any independent service or system that can be used by account security system 140 or authorization system 130 to supplement or support fraud or security systems. For example, fraud detection system 150 can include systems for detecting if a computer of merchant system 108 or a user device 124 has been compromised by malicious software or other security risks. Fraud detection as described herein can include the use of independent data identifying such issues, as well as communications and analysis operations performed with such devices before they are allowed to participate in secure transactions with account security system 140 and/or authorization system 130. Additional examples can include other such security and fraud detection schemes to support the implementation of secure transactions as described herein. Additional details of an account security system 140 are described below, and in various examples, fraud detection system(s) 150 can be implemented with varying degrees of integration with an account security system 140.

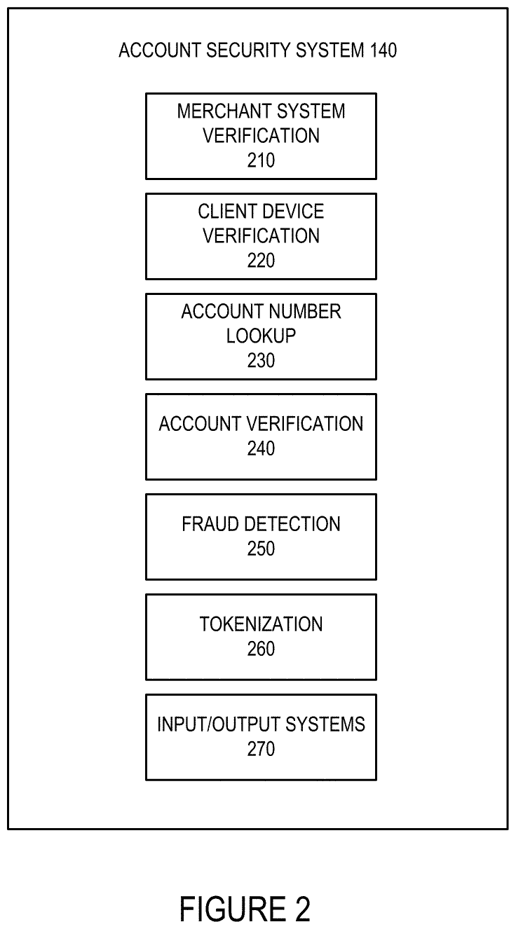

FIG. 2 depicts aspects of an example account security system 140, which can be used within a payment communication network 100 or other systems to implement data security as described herein. Account security system includes a number of different elements that can be implemented as modules or different devices networked to implement various security functions. In some examples, account security system 140 can be integrated with authorization system 130, while in other examples, account security system 140 can be a separate independent system. Account security system can be implemented as a single server, or as a distributed system using multiple networked devices. Input/output systems 270 can manage transmission of data and receipt of data both between different elements of the system 140 as well as with other devices, such as merchant servers and client devices, using any suitable network and communication components, such as those described below with respect to FIG. 14. The described elements of account security system 140 include merchant system verification 210, client device verification 220, account number lookup 230, account verification, fraud detection 250, and input/output systems 270. In other examples, these elements can be grouped in a variety of different ways. For example, client device verification 220 and fraud detection 250 can, in some examples, be structured as a single sub-system, or can be largely implemented as a separate system (e.g. using separate fraud detection system(s) 150). In various examples described below, the elements of account security system perform different parts of the operations to implement security as part of a secure transaction that uses modular elements to add to the security of larger systems.

Merchant system verification 210 interacts with merchant systems such as merchant system 108 to authenticate that the merchant is safe for a user to perform a transaction with. This verification can be done using security measures such as using security keys, transaction history data, merchant registration, and other verification tools. Merchant system verification 210 can create tokens that can be used as part of a secure transaction to allow participants in the transaction to confirm that they are interacting with verified participants that have met security standards and have access to the token generated by merchant system verification 210 for a specific transaction.

Client device verification 220 can include security operations to check for issues with a client's device, such as malicious software installed on a client device, a history of questionable transactions or fraud associated with a specific device, or other operations. This verification can be implemented via communication with a specific client device, accessing database data with fraud history data, or requiring installation of software on a client device to check for security issues with a client device. In some examples, merchant system verification 210 operations and client device verification 220 operations can be used as gateways for additional sub-systems, such that merchant systems and client devices are not allowed access or use of additional systems such as account number lookup 230 and account verification 240 unless the threshold requirements of merchant system verification 210 and client device verification 220 have been met.

Account number lookup 230 and account verification 240 interact with client devices to receive client data and access sensitive client account information. These operations can, for example, include receiving information such as an address, phone number, government identifier, or other such information, and using this information to access an account number associated with a client credit account. The client credit account number can then be provided to the client device or tokenization 260 element with an authorization to use the credit account with a specific secure transaction (e.g. a transaction associated with a client token generated by merchant system verification 210.) Similarly, account verification 240 can accept a client account number associated with the client credit account, and provide information such as an available balance to allow a client to confirm that the available balance is sufficient for a current secure transaction. The operations of account verification 240 and account number lookup 230 can be associated with a particular transaction, and used to trigger generation of tokenized client data by tokenization 260 element. This tokenization can involve generation of a one-time set of data that can be used only for a specific transaction. In some examples, after the tokenized client data is generated in response to account security system interacting with a client device, the tokenized client data is then stored until it is requested by the merchant system associated with the secure transaction, or until a deletion event occurs. Such deletion events can include a threshold amount of time, a number of incorrect requests for data associated with the client device or the client account, or other such events. If a deletion event occurs, a subsequent request for the data by the verified merchant can be met with a response indicating that the data has expired and the secure transaction is to be restarted (e.g. a new secure transaction initiated and the original transaction abandoned.)

Throughout operations for data security described herein, fraud detection 250 can monitor data and generate alerts or halt operations for a specific transaction when a risk of fraud is identified.

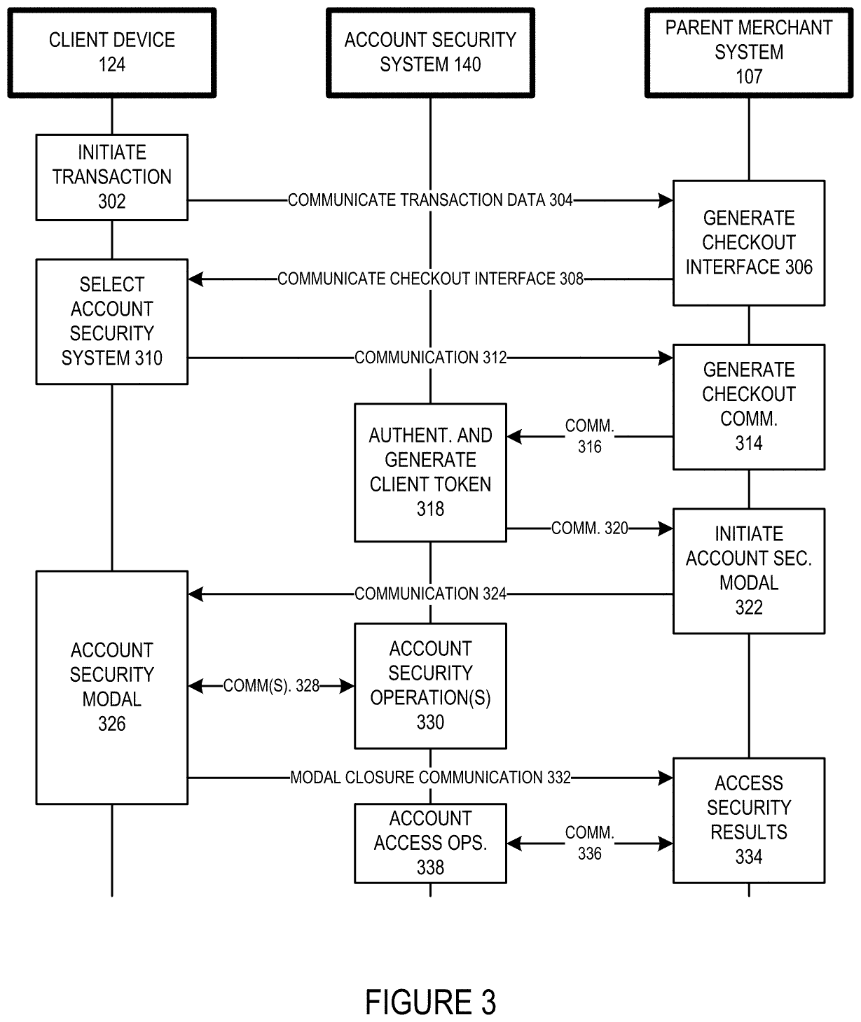

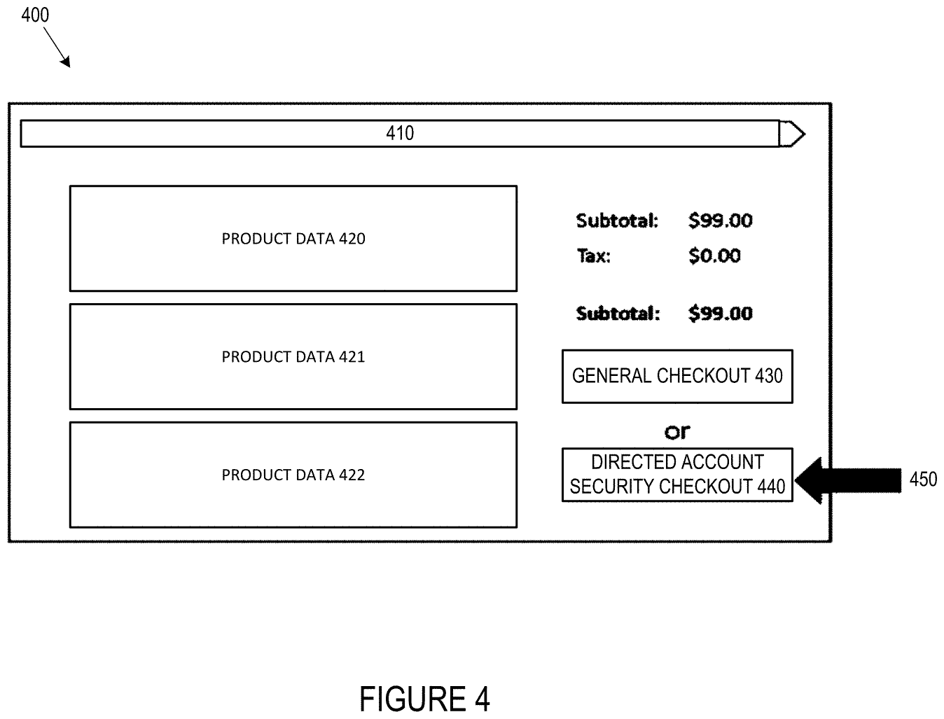

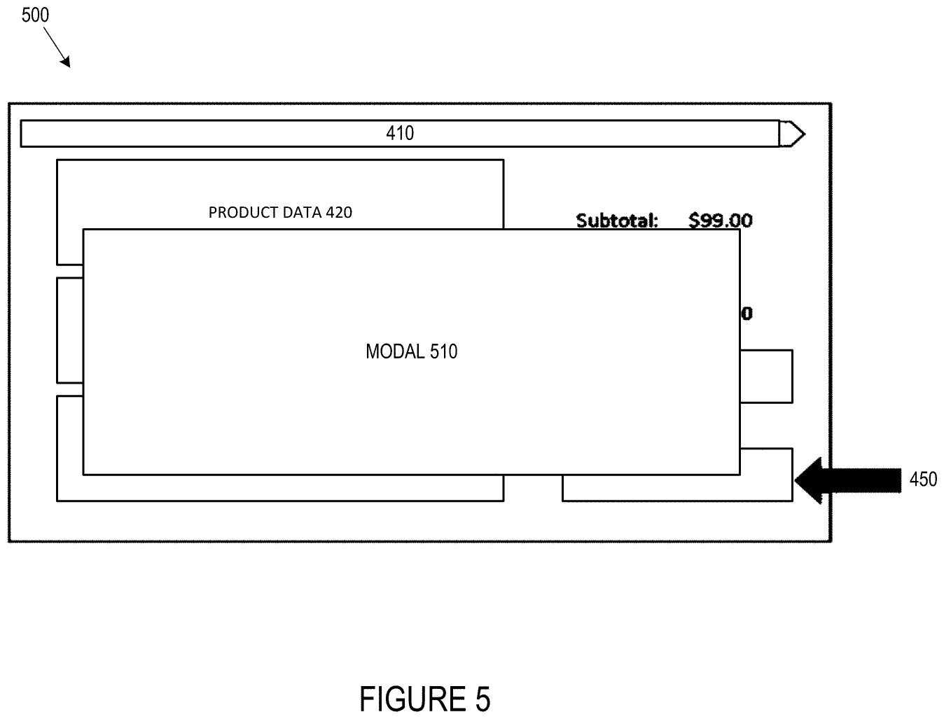

FIGS. 3-5 then describe an implementation of a secure transaction with data securing and a modular website implementation in accordance with some examples. FIGS. 4 and 5 illustrate aspects a modular website with an interface that can be displayed on a client device (e.g. client device 124) as part of data security operations for aspects of a secure transaction illustrated by FIG. 3.

FIG. 4 illustrates a user interface 400 with a transaction flow indicator 410, and product data 420, 421, and 422 for a plurality of products (e.g. products 128) that have been selected or indicated as part of a transaction using a merchant website (e.g. as part of parent merchant system 107). In some examples, the merchant website displays an invoice for a plurality of services performed by the plurality of child merchants. As described above, this can involve separate businesses operating under a parent payment system to aggregate payment for separate but related services. This can, for example, occur when independent contractors or sub-contractors work together under the umbrella of a parent payment structure. In one example, a website can be for a general contractor invoicing services and products for sub-contractors. In another example, this can be a medical, insurance, or hospital group providing a single invoice for affiliated but separate medical service providers. Another example is a vehicle repair organization where separate repair groups have associated bills for different portions of a vehicle repair. In each situation, a parent merchant structure that serves as a single point of contact for a client to pay a bill is present in a structure that allows the parent merchant to be authenticated as part of a secure transaction, and for the child merchants to settle payment for different portions of the transaction while the system relies of authentication of the parent. The user interface 400 includes a general checkout 430 interface element that can initiate payment operations using a general settlement system, or can used directed account security checkout 440 element. The directed account security checkout 440 interface element is a modular interface element that can be added to a website of a merchant in order to initiate data securing operations via an account security system in accordance with examples described herein. When a selection 450 of directed account security checkout 440 element occurs, a modal is launched to initiate a communication channel with an account security system (e.g. account security system 140), as illustrated by FIG. 5.

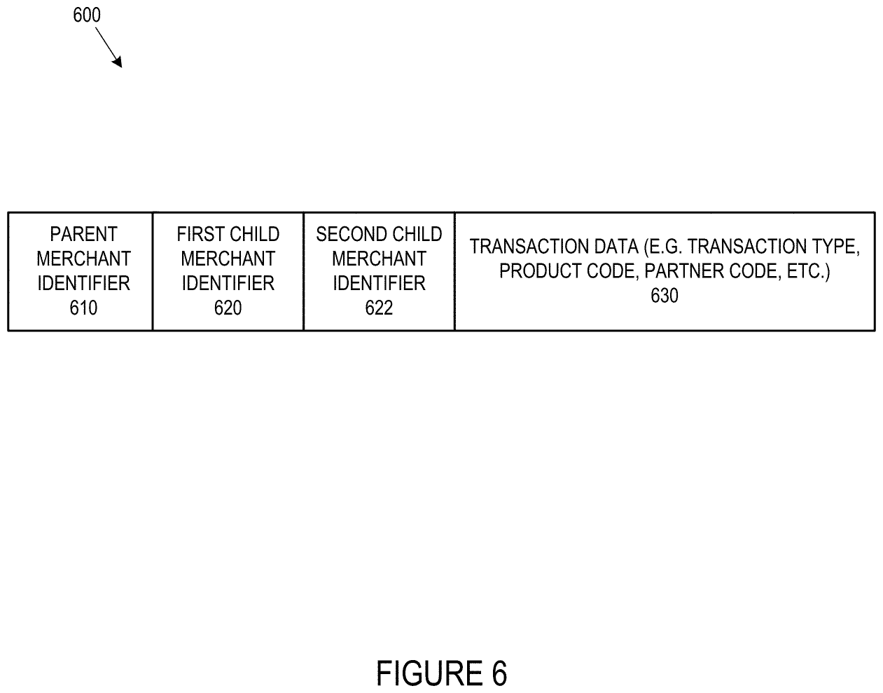

FIG. 5 shows a user interface 500 with modal 510 overlaying user interface 400. User interface 400 can be communicated to a client device from a merchant system, with various interactions with a merchant website leading to interface 400 being displayed on a screen of the user device. When selection 450 initiates modal 510, the modal 510 does not communicate via a merchant system, but establishes a communication channel with an account security system to keep sensitive client data separate from the merchant system. The modal 510 can then accept sensitive client data such as phone numbers, addresses, client identifiers, account numbers, and other such information. This information is kept separate from the merchant system, while the modal 510 allows modular integration of this independent data security structure (e.g. communications with data security system) within the context and user interface flow of the merchant website. Within the modal, multiple different user interfaces can be provided to a client for different operations that can be carried out with a client as part of a secure transaction. This can include user interfaces to allow a client to apply for credit to be used with the secure transaction. This can include an account number or account data lookup interface for accessing information associated with a client's current accounts that a client can use for a current transaction. This can also include interfaces for selecting an account to be used to settle payment for a transaction, and to authorize such payment. In all such systems, an account security system can operate via a modal to present a seamless website interface to a client while keeping sensitive client data isolated from merchant systems. This can include actions between an account security system and multiple client merchant systems to settle different portions of a secure transaction, while keeping sensitive client data secure from the different child merchant systems. Additionally, in some examples, different client merchant systems can have access to certain sensitive client information that other client merchant systems do not have access to. This can include, for example, descriptions of medical procedures provided by a child merchant. In such systems, the account security system can facilitate a single client interface for a secure transaction where sensitive client information (e.g. medical procedure descriptions) are provided to child merchant systems that are authorized to have this information as part of settlement (e.g. settling payment to a child merchant that performed a medical procedure), while other child merchants that provided other services as part of a single invoice, but that are not privy to the sensitive client information, are kept isolated from the sensitive client information. This secure isolation can be done with transaction data that is maintained separately for each child merchant identifier (e.g. as described below for FIG. 6), or via a table or other memory structure stored in a memory of an account security system or a checkout communication structure. Additional aspects of such interfaces are described below.

FIG. 3 illustrates system operations and communications for data security as part of a secure transaction involving client device 124, account security system 140, and parent merchant system 107 operating on behalf of a plurality of child merchant systems (e.g. child merchant 102 and child merchant 103). As indicated above, in various implementations, the parent merchant system 107 that performs the operations and participates in the communications described below can be integrated as part of a child merchant system, or can be independent and communicate separately with child merchant systems. Regardless of which structure is present, the parent merchant systems operate to allow a single authentication which can then be used in authorization and settling of separate sub-portions of a transaction that are associated with different child merchants.

As described in FIG. 3, in operation 302, client device 124 selects products or acknowledges an invoice with sub-portions from a plurality of child merchants as part of a secure transaction, and initiates the secure transaction (e.g. via a process to checkout selection of a user interface). Communication 304 informs parent merchant system 107 of the client device 124 selection, and in response, parent merchant system 107 generates a checkout interface (e.g. interface 400) in operation 306. The checkout interface includes a modular button, such as directed account security checkout 440 element of FIG. 4, and the data for the user interface is communicated from parent merchant system 107 to client device 124 in communication 308. In operation 310, the client device receives a selection for the account security system (e.g. selection 450), and this selection is communicated to parent merchant system 107 in communication 312.

In various implementations, the communications and operations of FIG. 3 can be performed in real-time or near real time. For example, communications between client device 124, account security system 140, and parent merchant system 107 (or any other merchant system) can occur in real-time or near real-time (e.g., as limited by processing speeds and latency in the devices and network) to provide a seamless user interface presentation as part of a transaction with merchant system 108. Additionally such communications and operations for a given transaction can occur simultaneously with communications and operations for other transactions, such that simultaneous real-time operations can be performed by a device or system for many transactions.

The parent merchant system 107 receives an indication of the selection for the account security system in operation 314, and generates a checkout communication in operation 314, that is sent to account security system 140 in communication 316. In response to the checkout communication, account security system operation 318 authenticates parent merchant system 107 to confirm that the merchant system is secure and has been validated. The account security system generates a client token when authentication is confirmed, and communicates the client token to parent merchant system 107 in communication 320. The client token can be used as different communications are made between server devices and client devices to maintain security during operations for the secure transaction. In some examples, the client token can be communicated with a postback identifier to allow tracking of the communications for the secure transaction, and to allow management of different transactions with different client devices and merchant systems that can continuously be interacting with account security system 140 to provide data security for secure transactions. In some examples, the communications operate without inherent tracking or synchronous verification that communications have occurred successfully. Postback information structures serve as verification that expected communications and operations have been performed. For example, after parent merchant system 107 sends a checkout communication, the parent merchant system can be configured to expect postback information in response to this communication. If the postback information is not received within a threshold period of time, the parent merchant system can generate an error, submit a query to determine the status of expected postback information, or resend the checkout communication with an indicator that this is a repeated communications is based on failure to receive respected postback information in response to a previous checkout communication. Postback information can thus be used to track the status of a particular secure transaction and identify when unexpected delays or errors are occurring with a particular secure transaction.

Parent merchant system 107 uses the client token from account security system to initiate the account security modal in operation 322 with communication 324, which can include the use of the client token in communication 324 that, when received by client device 124, allows the client device to perform security measures to confirm that parent merchant system 107 is a secure system and can safely perform the secure transaction. In operation 326, client device 124 opens a modal (e.g. modal 510 of user interface 500. From a client perspective, the modal opens in response to a user interface selection (e.g. selection 450), and appears as part of an interface for the parent merchant system 107 website. As described above, the modal opened in operation 326 is used with a communication channel established between client device 124 and account security system 140 for communications 328. Communications 328 for operations 326 and 330 can operate for various security operations, which can include operations to confirm that client device 124 is not presenting indications of a virus or security compromises, and can also include other fraud detection operations.

In some examples, the modal uses communications 328 to initiate authorization for payment to each child merchant system involved in a particular secure transaction. This can include checking authentication and security of both the client device and the parent merchant system to initiate authorization for payment to each child merchant system. In some examples, if an error or issue arises with any authorization of payment to any individual child merchant, the secure transaction can be canceled. In other examples, if some portions of the transaction with some child merchants are authorized while others are not, the modal can be used to communicate this information to the client device and request approval to continue with partial payment. If partial payment is authorized, then the modal informs the client device of outstanding portions of the transaction that remain to be completed. The modal can offer options to complete the remaining portions of the transaction, or provide information to allow the client to complete the remaining portions of the transaction at a later time.

In some examples, the modal can perform a string of secure operations for a secure transaction in communications 328. This can, for example, include a client device providing sensitive client data to an account security system for an account number lookup, followed by account data requests (e.g. for an available balance), followed by a credit application and response, followed by a payment authorization request and approval. During the account security system 140 portion of these functions in operations 330, tokenized client data can be generated in response to data and interface selections provided via the modal on client device 124. The tokenized client data can be stored at account security system 140 until requested by the merchant system in operations 334.

Processing of communications as part of a secure transaction and associated generation of the tokens and additional communications to facilitate modal presentation can occur in real-time or near real-time (e.g., limited by processing and network speeds and latency), such that computing devices facilitating communications and security operations automatically perform operations and provide information within a transaction that occurs within a brief time period (e.g., less than 0.1 seconds in some environments, less than 1 second in some environments, or less than 3 seconds in some environments). The near real-time operations and communications allows an account security system 140 to operate between a parent merchant system 107 and a client device 124 while minimally degrading the near real-time nature of communications for a transaction between client device 124 and parent merchant system 107, and improving device and system operation with added privacy and security. Further, in some implementations of real-time automatic operation, multiple instances of operations described above can occur simultaneously. For example, operation 306 for one transaction can occur simultaneously with any or every other operation of FIG. 3 for other transactions. Similarly, a single device implementing an account security system 140 can automatically perform multiple instances of each of operations 318, 330, and 338 for different transactions at the same time.

The modal of operations 326 can, in some examples, close without the client device providing adequate information for the client to access account data or for tokenized client data to be generated. In such a circumstance, the client device can proceed with the transaction using a separate system (e.g. returning to interface 400 and selecting the general checkout 430 user interface element). Data associated with this failure can be logged and used to check against future fraud indications.

When the modal does provide sufficient client data to account security system 140, closure of the modal on client device 124 can be considered the end of operations 326, and this closure can be communicated to parent merchant system 107 in communication 332. The closure causes parent merchant system 107 to request the security results from account security system in operation 334 using communications 336, which result in account security system responding with the tokenized client data in operations 338 and responsive communications 336. In some examples, upon providing the tokenized client data, the independent modular data security operations provided by account security system 140 can be considered complete.

FIG. 6 then describes an example communication 600 including aspects of standardized identifiers for multiple transaction authorizations that can be used with systems and methods for data security and transaction management in accordance with examples described herein. In some examples, communication 600 is a checkout communication, similar to communication 316 that can be generated by a parent merchant system and communicated to an account security system. This data from communication 600 allows a single merchant structured as a parent for multiple child merchants. This allows the child merchants to be part of joint transactions with the parent credentials (e.g. a merchant IDs and an associated password) used for authentication. Once the account security system authenticates the communication 600 and the parent MID 610, a response is created with the secured token that the merchant can use for initiating further aspects of the secured transaction (e.g. opening a modal on the client device).

The parent MID 610 can be used not only for authentication (e.g. with an associated password), but also to identify assets to be used by the account security system when a modal associated with the transaction and the parent is initiated with a client device (e.g. when the account security system receives a copy of the token in a communication from a client device). Implementing such operations in the account security system improves the operation of the network by eliminating a need to configure child merchant interfaces in modals associated with the child systems, but can instead allow matching interfaces for all transactions for all child merchants in transactions associated with a specific parent merchant. Where a single child merchant is associated with multiple parent merchants, the parent MID provided with the checkout communication will determine the interface associated with the child merchant in any modal on the client device. Thus, a first transaction associated with a first child merchant and a first parent merchant can provide a first interface in a modal at a client device when first child merchant specific elements of a modal interface are used. Then, for a second transaction associated with the first child merchant and a different second parent merchant, a different second interface can be used in a modal at the client device when the first child merchant specific elements of a modal interface are used for a second transaction. The parent MID can thus control child merchant interface elements presented in a modal for interaction with an account security system. The same child merchant can thus automatically have interfaces matched to different parents depending on the details of a specific transaction.

The first child merchant identifier 620 and the second child merchant identifier 622 can then be used to process aspects of the transaction associated with a particular child merchant system. In various examples, any number of different child merchant identifiers (e.g. four, ten, etc.) can be included in a checkout communication. In some examples, a common structure can be used for communications, even when only a single child merchant is involved in a transaction, in order to maintain simplicity in the system and reduce resources for handling different transactions. In other examples, when a merchant is involved in a transaction, a checkout communication can include a single merchant identifier.

Example communication 600 includes a parent merchant identifier 610, a first client merchant identifier 520, a second child merchant identifier 622, and transaction data 630. In some examples, additional data can be included, or various types of data can be integrated with transaction data 630. This can include a merchant account password, a child transaction type, a child product code, a partner code, or any such additional data. In some examples, additional information such as a partner code can allow partner level tracking of transactions. Any additional transaction data 630 can be used for tracking and fraud detection in various examples, such that history data and records of fraud matched to transaction data 630 can be stored and used to predict fraud in fraud detection systems used as part of an account security system.

In some examples, a parent MID 610 can be associated with a default configuration of a transaction type and a product code. As described above, different implementations can be used when a single child merchant is involved in a transaction. For example, in some implementations, a child MID can have interface and transaction type details that are specific to a child merchant. Similarly, any other such transaction data 630 can be specific to a child merchant when the child merchant is the only merchant involved in settling payment for a transaction. In some examples, when such a child merchant is involved in transactions with multiple child merchants, a parent merchant's default configuration of transaction type and product code transaction data 630 can override the default settings of a child merchant. In other examples, information for a child merchant transaction type and product code can override a parent merchant's default configuration. Such options provide flexibility for parent merchant structures and child merchants to organize and negotiate flexible data structures and data records while providing the benefits of the parent standardization where selected by merchants participating in the system.

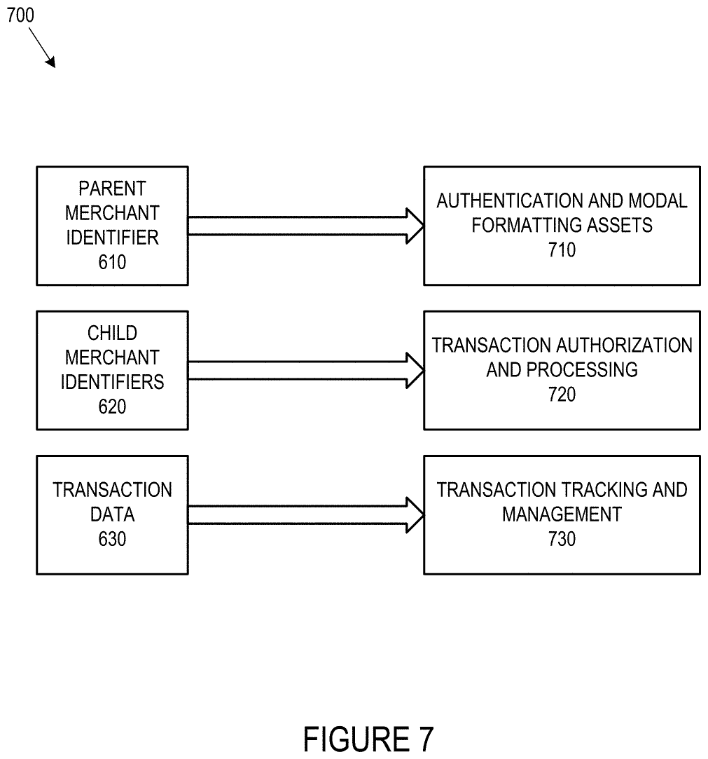

FIG. 7 depicts aspects of standardized identifiers for multiple transaction authorizations that can be used with systems and methods for data security and transaction management in accordance with examples described herein. FIG. 7 describes the data structure 700 associated with a checkout communication to an account security system, and the function associated with different aspects of such a data structure.

In particular, data structure 700 can be used for a communication such as communication 600 with a parent merchant identifier 610, one or more child merchant identifiers 620, and associated transaction data 630. In the example data structure 700, the identifiers and data can be associated with different security functionality in a network. As illustrated, parent merchant identifier 610 can be associated with authentication and modal formatting assets operations 710. The authentication can use the parent MID 610 with a password or other security assets in authenticating the parent merchant identifier, so that the child merchants associated with a secure transaction using data structure 700 can be considered secure. Additionally, as described above, tracking all child merchants under a parent MID allows standardized modal formatting assets, and reduces the overhead to repeat child merchant formatting assets for each child. The parent MID 610 thus provides a top-level shared set of data and security (e.g. an umbrella) under which the child merchants can operate with shared security and efficient sharing of formatting assets.

The child level under the parent level then uses child MIDs 620 for transaction authorization and processing 720 operations. The initial authentication of the parent can be used at the child level for basic security, and then the child merchants to receive portions of the payment for the secure transaction can individually perform authorization and settlement. The individual authorization and settlement allows the child merchants to manage and receive payments individually. As described above, a number of different business organizations that share parent-level structures while maintaining separate payment and products structures benefit organizationally from both the parent and child structures. Since payment in such structures will eventually be separated at a child merchant level, performing the settlement at this level improves the operation of a system by preventing redundant operations to separate out such payments outside of a shared (e.g. parent level) settlement that would then require complex structures to distribute payments to child merchants. Separating out settlement at the child merchant level efficiently uses the network and computing resources of a transaction system.

Transaction data 630 can then be used in any number of ways for transaction tracking and management 730 operations. As described above, history data in a variety of formats can be used for fraud detection. Additionally, product level data, program level data, and any other such transaction data can be used by a child merchant for business operations and performance evaluation. In some examples, parent level transaction data for multiple child merchants can provide metrics for sharing costs associated with implementing parent merchant systems that are shared across multiple child merchants. In other examples, machine learning and artificial intelligence (e.g. convolutional neural networks) can be used with transaction data to evaluate not only product performance and fraud, but to identify additional correlations between and within child merchant operations that can be improved.

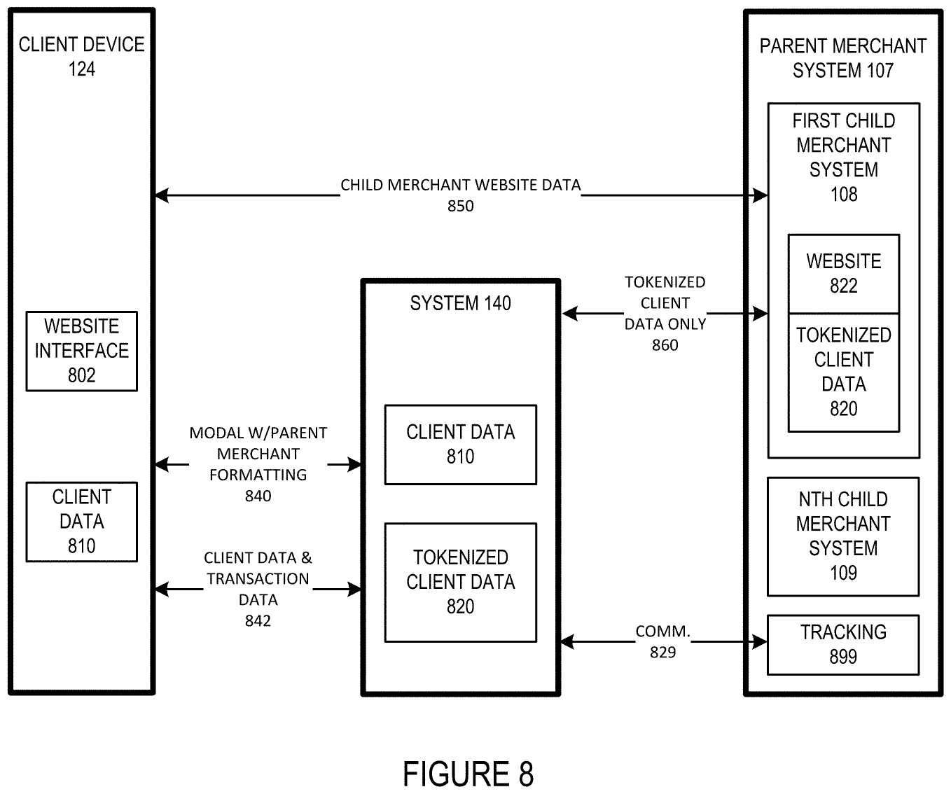

FIG. 8 depicts aspects of a system and system operations for data security and transaction management in accordance with some examples. FIG. 8 particularly shows how sensitive client data is isolated from merchant systems. As illustrated, client device 124 can include client data 810 provided by a client or user of the client device 124. In the secure transaction illustrated above and in additional examples, communication of client data in communications 840 occurs with account security system 140 and may occur with authorization and payment settlement systems which can have access to sensitive client data 810. The parent merchant system 107, however, is isolated from this client data 810, so that parent merchant system 107 only receives tokenized client data 820 in communication(s) 860. This tokenized data received by parent merchant system 107 is secure, so that the tokenized data does not allow parent merchant system 107 access to or sensitive information associated with the client data used to generate the tokenized data. As described above, the tokenized client data 820 is generated in system 140, and is generated to obscure the actual client data, while allowing the merchant system to interact with system 140 to facilitate payment and other secure interactions with client data.

The use of account security system 140 provides benefits to a system in which parent merchant system 107 and associated payment systems have fixed structures or implementations that would require significant resources or changes to implement the account lookup and account verification features. The use of account security system 140 enables such functionality with minor modular user interface changes by parent merchant system 107 web site implementations, so that the security of the system 140 and communications with parent merchant system 107 are improved without these systems needing to be replaced.

In addition to secure management of client data via communication 860 and communication 842, the parent merchant system 107 operating with client device 124 and system 140 allows management of the transaction associated website 822 and the website interface 802 of client device 124. The parent and child structure allows communication 840 to provide shared merchant formatting data to a modal on client device 124 that provides website interface 802, while the core merchant website data is provided by parent merchant system 107 in communications 850. Similarly, communications 829 between the parent merchant system 107 and system 140 can allow a tracking 899 system of parent merchant system 107 or similar modules in system 140 to provide data analysis, fraud detection, and other such services within the context of existing structures and while providing security and privacy protection for client data.

Similar to FIG. 3 above, FIG. 8 illustrates operations that can be implemented as real-time automatic operations, where multiple instances of operations described above can occur simultaneously. For example, a single device implementing merchant system 108 can automatically perform multiple (e.g., thousands of simultaneous) instances of each of the operations described in FIGS. 3 and 8 for different transactions at the same time.

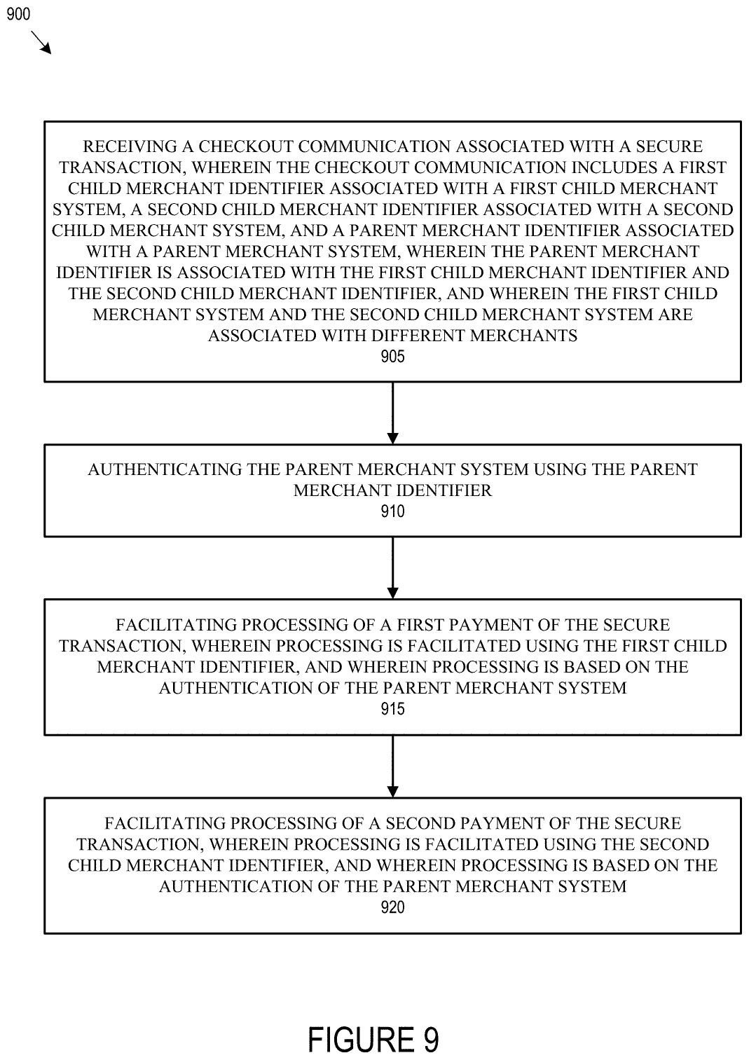

FIG. 9 is a flow diagram illustrating an example method 900. Method 900 can be performed by one or more processors of a server computer or server system as part of an account security system (e.g. account security system 140). Method 900 can, in some examples, be implemented as computer readable instructions that, when executed by processing circuitry of a device, cause the device to perform steps of method 900.

Operation 905 of method 900 includes receiving a checkout communication associated with a secure transaction. A checkout communication can be a communication such as communication 316 of FIG. 3 between a parent merchant system 107 and an account security system 140. The checkout communication in some examples includes a parent merchant identifier and at least one child merchant identifier, along with transaction data. In some examples, the checkout communication includes at least two child merchant identifiers, which can be structured as a first child merchant identifier associated with a first child merchant system and a second child merchant identifier associated with a second child merchant system, similar to communication 600 of FIG. 6. In such examples, a parent merchant identifier associated with a parent merchant system is included in the checkout communication, where the parent merchant identifier is associated with the first child merchant identifier and the second child merchant identifier, and where the first child merchant system and the second child merchant system are associated with different merchants. As described above, in some examples, the child merchant systems are independent servers and websites which integrate functionality as part of a shared parent merchant system. Such an example can occur, for example, where a primary service provider (e.g. a primary care doctor, a primary business contact, a general contractor, etc.) serves as a lead for a transaction involving multiple different independent service providers (e.g. independent medical specialists, subcontractors, etc.) In other examples, a parent merchant system can be an umbrella organization that simply organizes merchants that operate under the structure of the parent merchant. In both cases, the parent merchant identifier is not associated with a payment, but is an organizational structure that can be used for authentication, with payments as part of the secure transaction made to the child merchant systems.

Operation 910 of method 900 then involves authenticating the parent merchant system using the parent merchant identifier. This authentication can, in some examples, involve a combination of a parent MID with a password from the checkout communication. This can, in some examples, include a multi-factor authentication process or a token security process between a merchant server representing the parent structure, and an account security system server. In some examples, the child merchant systems can also register or can be securely structured or registered with the parent merchant system. In some examples, each child merchant can register using child merchant information, secure tokens for registering with a parent merchant system, or other such structures to affiliate the parent merchant identifier with the child systems that operate with the parent system. Such affiliations then allow the child merchant systems to authorize and settle payments independently as part of a secure transaction.

In some implementations, authentication can be dynamically processed in real-time to improve the security of the system while maintaining quality of service (e.g., overall system responsiveness to client device 124 communications) and improving system performance with the use of a parent MID as described above. An account security system 140 can perform automatic and real-time processing operation 910 as well as operations 915 and 920 below for many customers simultaneously (e.g., thousands of checkout communications per minute, thousands of checkout communications per second, or more depending on system configurations).

The authentication of the parent system then allows method 900 to continue with both operation 915 and operation 920 to facilitate processing of payments to different child merchant systems. Operation 915 includes facilitating processing of a first payment of the secure transaction, where processing is facilitated using the first child merchant identifier, and where processing is based on authentication of the parent merchant system. Operation 920 includes facilitating processing of a second payment of the secure transaction, where processing is facilitated using the second child merchant identifier, and where processing is based on authentication of the parent merchant system.

Some such examples can further operate by storing transaction details associated with the checkout communication for parent level tracking associated with the parent merchant identifier, where the checkout communication further includes a child transaction type, a child product code, or a partner code to facilitate the parent level tracking. This tracking can include storing history data for transaction types, fraud, payment totals or payment fraud issues broken down by child merchant, program details, or other such transaction data. In some examples, this data can be analyzed using convolutional neural networks or other machine learning tools to predict fraud. In further examples, such data can be used to report usage and payment histories among merchants, and to allocate parent merchant costs among child merchant systems based on transaction data. This can include proportional costs based on a total amount of payment received for each child merchant over a set time period. This can include a combination of fixed costs per child merchant and proportional costs based on total payments received, or other such structures. In some systems, where clients provide feedback on an overall transaction, the transaction history for multiple transactions can be analyzed to identify trends in client feedback based on certain combinations of child merchants. Such examples can further process communications automatically (e.g., without human intervention) at high volume in real-time or near real-time (e.g., thousands of communications per second or per fraction of a second in some implementations).

Some examples can further perform operations including accessing, in response to the checkout communication, one or more website assets associated with the parent merchant system using the parent merchant identifier, receiving an account communication, and opening a secure channel with a client device in response to the checkout communication. In some such examples, the account communication is received from the client device via a modal on the client device generated as part of the secure channel. The one or more website assets can then be transmitted to the client device as part of a modal user interface. The first payment to the first child merchant system and the second payment to the second child merchant system can then be facilitated using the one or more website assets.

Some examples include operations for receiving an account communication including a client token and client information, where the client information is not received from the parent merchant system, the first child merchant system, or the second child merchant system. At least a first tokenized client account number can be generated and used in facilitating the first payment to allow payment processing without the parent merchant system, the first child merchant system, or the second child merchant system accessing the client information. In some such examples, a single tokenized client account number can be used for each payment with each child merchant system. In some examples, a different tokenized client account number is generated for each child merchant system or for each payment and settlement operations as part of a secure transaction (e.g. for one transaction under a parent merchant).

In some examples, a secure token is generated for a transaction to allow secure communications between networked devices facilitating the secure transaction. This can include operations for generating a client token in response to authentication of the parent merchant system and transmitting the client token. As mentioned above, the client token enables secure communications. For example, when the client token is received at a client device associated with the secure transaction the client token is used to verify the parent merchant system to the client device.

In some examples, postback data is generated with the client token. The client token can then be used for secure communications as part of the postback data, and the postback data can additionally include other related information about a secure transaction, such as a transaction status, a record of previous operations as part of a secure transaction, data to be used in updating a user interface for a website involved in the secure transaction, or other such data. For example, in one implementation, transmitting the client token comprises transmitting the postback data with the client token to a secure uniform resource locator associated with a website for the parent merchant system.

Some examples further involve opening a secure channel with a client device associated with the secure transaction and receiving an account communication. The account communication can be received from the client device via a modal on the client device generated as part of the secure channel, as described above. In some such examples, additional operations can be performed using the modal, including one or more of a secure account number lookup, a payment authorization, or an account balance lookup using the secure channel and the modal.

Similar to the examples above related to method 900, another example can include receiving, at an account security system including one or more processors, a checkout communication associated with a secure transaction. In some such examples, the checkout communication includes a parent merchant identifier associated with a plurality of merchant systems and a child merchant identifier associated with a first child merchant system of the plurality of merchant systems, where the checkout communication does not include client information. The checkout communication can be authenticated by using the parent merchant identifier (e.g. with a password, token, or other security measure) to confirm that the first child merchant system is associated with a validated checkout system. A client token is generated associated with the first child merchant system in response to the authenticating of the checkout communication, and then transmitted. When the client token is received at a client device the client token is used to verify the first child merchant system to the client device. This example then involves receiving an account communication including the client token and the client information, where the client information is not received from the first child merchant system, and generating a tokenized client account number using the first child merchant identifier, wherein the tokenized client account number is generated in response to the account communication. The tokenized client account number can then be used for authorization by a child merchant system. In some examples, the tokenized client account number is transmitted, such that when the tokenized client account number is received at the first child merchant system, the tokenized client account number facilitates processing of the secure transaction without the first merchant system having access to the client information.

These operations can, in various examples, be integrated with other operations for account security and operation of an account security system as described herein. In some examples, such operations can be repeated, can include intervening operations, or can be performed concurrently for any number of secure transactions between different merchant systems and client devices. It will therefore be apparent that while method 900 describes one example implementation, other implementations are also possible in accordance with the details provided herein.

In various implementations some or all of the operations described above can be performed in real-time or near real-time. The real-time operations can include some or all of the operations 905 through 930 of method 900. Such automatic operations improve a system by enabling real-time or near real-time transactions with latencies and responsiveness in automatic operations not possible when operations involve human interaction (e.g., non-automatic operation). Additionally, operations can occur simultaneously as part of a single system processing multiple transactions, such that the generating operation 910 for a first transaction can occur simultaneously with the generating operation 920 for another transaction. Similarly, communications for other transactions can be in process while such generating operations occur as part of operations facilitated by a single device or a system that includes one or more devices configured to implement method 900 or other operations described herein. For example, the operations described above can be performed automatically by an account security system 140 in a network, without human interaction as part of the account security system 140 operations. Similarly, merchant system 108 and client device 124 can perform certain operations automatically (e.g., without human interaction or involvement). For example, a client device 124 can receive a non-automatic input (e.g., involving a human interaction with client device 124), which initiates a chain of automatic operations at merchant system 108, account security system 140, and client device 124 without further human involvement (e.g., automatic operations flowing from an initial non-automatic operation triggered by a human input at an interface of client device 124). Such automatic operations improve a system by enabling real-time or near real-time transactions with latencies and responsiveness in automatic operations not possible when operations involve human interaction (e.g., non-automatic operation).

FIG. 10 illustrates a computing system architecture 1000 including various components in electrical communication with each other using a connection 1006, such as a bus, in accordance with some implementations. Example system architecture 1000 includes a processing unit (CPU or processor) 1004 and a system connection 1006 that couples various system components including the system memory 1020, such as ROM 1018 and RAM 1016, to the processor 1004. The system architecture 1000 can include a cache 1002 of high-speed memory connected directly with, in close proximity to, or integrated as part of the processor 1004. The system architecture 1000 can copy data from the memory 1020 and/or the storage device 1008 to the cache 1002 for quick access by the processor 1004. In this way, the cache can provide a performance boost that avoids processor 1004 delays while waiting for data. These and other modules can control or be configured to control the processor 1004 to perform various actions.

Other system memory 1020 may be available for use as well. The memory 1020 can include multiple different types of memory with different performance characteristics. The processor 1004 can include any general purpose processor and a hardware or software service, such as service 1 1010, service 2 1012, and service 3 1014 stored in storage device 1008, configured to control the processor 1004 as well as a special-purpose processor where software instructions are incorporated into the actual processor design. The processor 1004 may be a completely self-contained computing system, containing multiple cores or processors, a bus, memory controller, cache, etc. A multi-core processor may be symmetric or asymmetric.

To enable user interaction with the computing system architecture 1000, an input device 1022 can represent any number of input mechanisms, such as a microphone for speech, a touch-sensitive screen for gesture or graphical input, keyboard, mouse, motion input, speech and so forth. An output device 1024 can also be one or more of a number of output mechanisms known to those of skill in the art. In some instances, multimodal systems can enable a user to provide multiple types of input to communicate with the computing system architecture 1000. The communications interface 1026 can generally govern and manage the user input and system output. There is no restriction on operating on any particular hardware arrangement and therefore the basic features here may easily be substituted for improved hardware or firmware arrangements as they are developed.

Storage device 1008 is a non-volatile memory and can be a hard disk or other types of computer readable media which can store data that are accessible by a computer, such as magnetic cassettes, flash memory cards, solid state memory devices, digital versatile disks, cartridges, RAMs 1016, ROM 1018, and hybrids thereof.

The storage device 1008 can include services 1010, 1012, 1014 for controlling the processor 1004. Other hardware or software modules are contemplated. The storage device 1008 can be connected to the system connection 1006. In one aspect, a hardware module that performs a particular function can include the software component stored in a computer-readable medium in connection with the necessary hardware components, such as the processor 1004, connection 1006, output device 1024, and so forth, to carry out the function.

The disclosed gift selection, attribution, and distribution system can be performed using a computing system. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device. The processor may be configured to carry out all or part of methods described herein for example by executing code for example stored in memory. One or more of a user device or computer, a provider server or system, or a suspended database update system may include the components of the computing system or variations on such a system.

This disclosure contemplates the computer system taking any suitable physical form, including, but not limited to a Point-of-Sale system (“POS”). As example and not by way of limitation, the computer system may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud, which may include one or more cloud components in one or more networks. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor may be, for example, be a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor. The memory can be coupled to the processor by, for example, a bus. The memory can include, by way of example but not limitation, random access memory (RAM), such as dynamic RAM (DRAM) and static RAM (SRAM). The memory can be local, remote, or distributed.

The bus can also couple the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software can be stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The bus can also couple the processor to the network interface device. The interface can include one or more of a modem or network interface. It will be appreciated that a modem or network interface can be considered to be part of the computer system. The interface can include an analog modem, Integrated Services Digital network (ISDN) modem, cable modem, token ring interface, satellite transmission interface (e.g., “direct PC”), or other interfaces for coupling a computer system to other computer systems. The interface can include one or more input and/or output (I/O) devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device.

In operation, the computer system can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux™ operating system and its associated file management system. The file management system can be stored in the non-volatile memory and/or drive unit and can cause the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any system capable of executing a set of instructions (sequential or otherwise) that specify actions to be taken by that system.

While the machine-readable medium or machine-readable storage medium is shown, by way of example, to be a single medium, the terms “computer readable medium”, “computer readable storage medium”, “machine-readable medium” and “machine-readable storage medium” should be taken to include a single medium or multiple media (e.g., a centralized or distributed database, and/or associated caches and servers) that store the one or more sets of instructions. The terms “computer readable medium”, “computer readable storage medium”, “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting the subject matter to the precise forms disclosed. Persons skilled in the relevant art can appreciate that many modifications and variations are possible in light of the above disclosure. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

It is also noted that individual implementations may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included (e.g. in FIG. 8). A process may correspond to a method, a function, a procedure, a subroutine, a subprogram, etc. When a process corresponds to a function, its termination can correspond to a return of the function to the calling function or the main function.

Client devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things. The input devices can include, for example, a keyboard, a mouse, a key pad, a touch interface, a microphone, a camera, and/or other types of input devices. The output devices can include, for example, a display screen, a speaker, a haptic feedback system, a printer, and/or other types of output devices. A data storage device, such as a hard drive or flash memory, can enable the computing device to temporarily or permanently store data. A network interface, such as a wireless or wired interface, can enable the computing device to communicate with a network. Examples of computing devices include desktop computers, laptop computers, server computers, hand-held computers, tablets, smart phones, personal digital assistants, digital home assistants, as well as machines and apparatuses in which a computing device has been incorporated.

The various examples discussed above may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments). A processor(s), implemented in an integrated circuit, may perform the necessary tasks.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method, comprising:
receiving a checkout communication associated with a secure transaction, wherein the checkout communication includes a first child merchant identifier associated with a first child merchant system, a second child merchant identifier associated with a second child merchant system, and a parent merchant identifier associated with a parent merchant system, wherein the parent merchant identifier is associated with the first child merchant identifier and the second child merchant identifier, and wherein the first child merchant system and the second child merchant system are associated with different merchants;
authenticating the parent merchant system using the parent merchant identifier;
automatically facilitating processing of a first payment of the secure transaction, wherein processing is facilitated using the first child merchant identifier, and wherein processing is based on authentication of the parent merchant system; and
automatically facilitating processing of a second payment of the secure transaction, wherein processing is facilitated using the second child merchant identifier, and wherein processing is based on authentication of the parent merchant system.

2. The computer-implemented method of claim 1 further comprising storing transaction details associated with the checkout communication for parent level tracking associated with the parent merchant identifier; and
wherein the checkout communication further includes a child transaction type, a child product code, or a partner code to facilitate the parent level tracking.

3. The computer-implemented method of claim 1 further comprising:
accessing, in response to the checkout communication, one or more website assets associated with the parent merchant system using the parent merchant identifier;
receiving an account communication;
opening a secure channel with a client device in response to the checkout communication, wherein the account communication is received from the client device via a modal on the client device generated as part of the secure channel;
transmitting the one or more website assets to the client device as part of a modal user interface; and
facilitating the first payment to the first child merchant system and the second payment to the second child merchant system using the one or more website assets.

4. The computer-implemented method of claim 1 further comprising:
receiving an account communication including a client token and client information, wherein the client information is not received from the parent merchant system, the first child merchant system, or the second child merchant system;
generating at least a first tokenized client account number; and
facilitating the first payment using the first tokenized client account number to allow payment processing without the parent merchant system, the first child merchant system, or the second child merchant system accessing the client information.

5. The computer-implemented method of claim 1 further comprising:
generating a client token in response to authentication of the parent merchant system; and
transmitting the client token, wherein when the client token is received at a client device associated with the secure transaction, and wherein the client token is used to verify the parent merchant system to the client device.

6. The computer-implemented method of claim 5 further comprising:
generating postback data with the client token; and
wherein transmitting the client token comprises transmitting the postback data with the client token to a secure uniform resource locator associated with a web site for the parent merchant system.

7. The computer-implemented method of claim 1 further comprising:
opening a secure channel with a client device associated with the secure transaction; and
receiving an account communication, wherein the account communication is received from the client device via a modal on the client device generated as part of the secure channel.

8. The computer-implemented method of claim 7 further comprising performing one or more of a secure account number lookup, a payment authorization, or an account balance lookup using the secure channel and the modal.

9. A system comprising:
a memory configured to store a checkout communication associated with a secure transaction, wherein the checkout communication includes a first child merchant identifier associated with a first child merchant system, a second child merchant identifier associated with a second child merchant system, and a parent merchant identifier associated with a parent merchant system, wherein the parent merchant identifier is associated with the first child merchant identifier and the second child merchant identifier, and wherein the first child merchant system and the second child merchant system are associated with different merchants; and
one or more processors coupled to the memory and configured to perform operations comprising:
authenticating the parent merchant system using the parent merchant identifier;
automatically facilitating processing of a first payment of the secure transaction, wherein processing is facilitated using the first child merchant identifier, and wherein processing is based on authentication of the parent merchant system; and
automatically facilitating processing of a second payment of the secure transaction, wherein processing is facilitated using the second child merchant identifier, and wherein processing is based on authentication of the parent merchant system.

10. The system of claim 9, wherein the one or more processors are further configured for operations including:
storing transaction details associated with the checkout communication for parent level tracking associated with the parent merchant identifier; and
wherein the checkout communication further includes a child transaction type, a child product code, or a partner code to facilitate the parent level tracking.

11. The system of claim 9, wherein the one or more processors are further configured for operations including:
accessing, in response to the checkout communication, one or more website assets associated with the parent merchant system using the parent merchant identifier;
receiving an account communication;
opening a secure channel with a client device in response to the checkout communication, wherein the account communication is received from the client device via a modal on the client device generated as part of the secure channel;
transmitting the one or more website assets to the client device as part of a modal user interface; and
facilitating the first payment to the first child merchant system and the second payment to the second child merchant system using the one or more website assets.

12. The system of claim 11, wherein the one or more processors are further configured for operations including:
receiving an account communication including a client token and client information, wherein the client information is not received from the parent merchant system, the first child merchant system, or the second child merchant system;
generating at least a first tokenized client account number; and
facilitating the first payment using the first tokenized client account number to allow payment processing without the parent merchant system, the first child merchant system, or the second child merchant system accessing the client information.

13. The system of claim 9, wherein the one or more processors are further configured for operations including:
generating a client token in response to authentication of the parent merchant system;
transmitting the client token, wherein when the client token is received at a client device associated with the secure transaction, and wherein the client token is used to verify the parent merchant system to the client device;
generating postback data with the client token; and
wherein transmitting the client token comprises transmitting the postback data with the client token to a secure uniform resource locator associated with a web site for the parent merchant system.

14. The system of claim 9, wherein the one or more processors are further configured for operations including:
opening a secure channel with a client device associated with the secure transaction;
receiving an account communication, wherein the account communication is received from the client device via a modal on the client device generated as part of the secure channel; and
comprising performing one or more of a secure account number lookup, a payment authorization, or an account balance lookup using the secure channel and the modal.

15. A non-transitory computer readable medium comprising instructions that, when executed by one or more processors of a device, cause the device to perform operations comprising:
receiving a checkout communication associated with a secure transaction, wherein the checkout communication includes a first child merchant identifier associated with a first child merchant system, a second child merchant identifier associated with a second child merchant system, and a parent merchant identifier associated with a parent merchant system, wherein the parent merchant identifier is associated with the first child merchant identifier and the second child merchant identifier, and wherein the first child merchant system and the second child merchant system are associated with different merchants;
authenticating the parent merchant system using the parent merchant identifier;
automatically facilitating processing of a first payment of the secure transaction, wherein processing is facilitated using the first child merchant identifier, and wherein processing is based on authentication of the parent merchant system; and
automatically facilitating processing of a second payment of the secure transaction, wherein processing is facilitated using the second child merchant identifier, and wherein processing is based on authentication of the parent merchant system.

16. The non-transitory computer readable medium of claim 15, wherein the operations further cause the device to perform operations comprising:
storing transaction details associated with the checkout communication for parent level tracking associated with the parent merchant identifier; and
wherein the checkout communication further includes a child transaction type, a child product code, or a partner code to facilitate the parent level tracking.

17. The non-transitory computer readable medium of claim 15, wherein the operations further cause the device to perform operations comprising:
accessing, in response to the checkout communication, one or more website assets associated with the parent merchant system using the parent merchant identifier;
receiving an account communication;
opening a secure channel with a client device in response to the checkout communication, wherein the account communication is received from the client device via a modal on the client device generated as part of the secure channel;
transmitting the one or more website assets to the client device as part of a modal user interface; and
facilitating the first payment to the first child merchant system and the second payment to the second child merchant system using the one or more website assets.

18. The non-transitory computer readable medium of claim 15, wherein the operations further cause the device to perform operations comprising:
receiving an account communication including a client token and client information, wherein the client information is not received from the parent merchant system, the first child merchant system, or the second child merchant system;
generating at least a first tokenized client account number; and
facilitating the first payment using the first tokenized client account number to allow payment processing without the parent merchant system, the first child merchant system, or the second child merchant system accessing the client information.

19. The non-transitory computer readable medium of claim 15, wherein the operations further cause the device to perform operations comprising:
generating a client token in response to authentication of the parent merchant system;
transmitting the client token, wherein when the client token is received at a client device associated with the secure transaction, and wherein the client token is used to verify the parent merchant system to the client device;
generating postback data with the client token; and
wherein transmitting the client token comprises transmitting the postback data with the client token to a secure uniform resource locator associated with a web site for the parent merchant system.

20. The non-transitory computer readable medium of claim 15, wherein the operations further cause the device to perform operations comprising:
opening a secure channel with a client device associated with the secure transaction;
receiving an account communication, wherein the account communication is received from the client device via a modal on the client device generated as part of the secure channel; and
performing one or more of a secure account number lookup, a payment authorization, or an account balance lookup using the secure channel and the modal.
